(19) United States
(12) Patent Application Publication
(10) Pub. No.: US 2015/0375185 A1
(43) Pub. Date: Dec. 31, 2015

(54) MIXING DEVICE

(71) Applicants: Dietmar WAIZENAUER, Kematen an der Krems (AT); Bernhard WAIZENAUER, Allhaming (AT)

(72) Inventors: Dietmar WAIZENAUER, Kematen an der Krems (AT); Bernhard WAIZENAUER, Allhaming (AT)

(21) Appl. No.: 14/434,918

(22) PCT Filed: Sep. 4, 2013
(86) PCT No.: PCT/AT2013/050171

§ 371 Date: Aug. 24, 2015

(30) Foreign Application Priority Data
Oct. 10, 2012 (AT) A 1097/2012

(51) Int. Cl. B01F 15/02; B01F 3/08

(52) U.S. Cl. CPC B01F 15/0243; B01F 3/08; B01F 15/026

(57) ABSTRACT

A mixing device for mixing at least two liquids is provided. The mixing device includes at least two containers, each of which contains a liquid, and at least two pumps for delivering the liquids. Each of the pumps is arranged at one of the containers. The pumps are screw spindle pumps and are connected to a follower plate. The follower plate is vertically adjustable and rests on the surface of a respective liquid, thereby sealing the respective container.

### CROSS-REFERENCE TO RELATED APPLICATIONS

This application is a Section 371 of International Application No. PCT/AT2013/050171, filed Sep. 4, 2013, which was published in the German language on Apr. 17, 2014 under International Publication No. WO 2014/056011 A2 and the disclosure of which is incorporated herein by reference.

### BACKGROUND OF THE INVENTION

Emptying containers containing liquids is a routine process in the industrial field. Many chemicals and other raw materials, such as oils, sealants and adhesives, are supplied as liquids to the manufacturing industry. To use such liquids in production processes, the liquids must be taken out of their containers and supplied to the respective production process.

The facilities available on the market use extrusion pumps (e.g., chop check pumps) as conveyor units. Depending on the manufacturer, these pumps are driven pneumatically, hydraulically or electrically. Extrusion pumps have to be driven in a linear way and deliver an intermittent (e.g., a pulsating) flow of material, as such pumps have a dead center and their direction of movement cannot be changed very quickly. Extrusion pumps deliver materials volumetrically only to a limited extent. That is, it is not possible to exactly define the quantities supplied by one stroke, as an undefined quantity of material is supplied when the direction of movement is changed. The integrated check valves open and close differently depending on the viscosity of the respective material. An extrusion pump thus has system-immanent disadvantages which are to be avoided in everyday work processes. Due to the operating principle of extrusion pumps, they have to “scoop” below the follower plate or the pump case, thus leaving a significant residue in the barrel or in the feeding hopper of the follower plate.

A device for emptying containers may be further used for mixing liquids from two different containers. Principally, there are supply facilities which have fixed mixing ratios and variable mixing ratios.

### Constant Mixing Ratio of 1:1

The extrusion pump has to be coupled mechanically, hydraulically or electrically, to make sure that its position, and thus the time when its direction of movement is changed, remain the same at any point in time. As the viscosity of components A and B may differ greatly, depending on the respective manufacturers, it is possible that the volumetric mixing ratio varies. In addition, it is not possible to take unevenly filled material containers into account, so that large quantities of one component are left over.

### Variable Mixing Ratio

The mixing ratio can be chosen freely. The feed pumps operate independently of one another, mixing the media at a set mixing ratio with a specified permissible variation. In case of variable mixing ratios, it is additionally possible that the material level in the respective barrels influences the supplied quantities of each component to make sure that the containers are evenly emptied. When setting a variable mixing ratio, the delivery units of components A and B are not coupled to each other. Depending on the respective manufacturer, volumetric measuring devices may be integrated into the tube to control the supplied quantities. The delivery pressure of current systems amounts to approximately 150 to 200 bar, depending on viscosity and tube length. To achieve a constant delivery pressure, a pressure reducing valve, which reduces the pressure within the facility to a value which is set to be constant in order to compensate for variations of the feed pumps, is integrated into the end of the tube.

EP 1 331 072 B1 describes a process for controlling a device for withdrawing liquid materials from containers using an extrusion pump. The extrusion pumps are driven by different impulse frequencies.

DE 20 2011 108 222 U1 describes a device for discharging liquid components of a multiple-component recipe. The device includes conveyor devices having a pump operated by electrical drive sensors which determine the level within containers and are connected to a control and regulating device which controls the discharging of the components. An extrusion pump arranged on a follower plate is mentioned as an example of such a pump.

### BRIEF SUMMARY OF THE INVENTION

The present invention relates to a mixing device for mixing at least two liquids, as well as to a process for mixing at least two liquids.

An objective of the present invention is to provide a device for mixing at least two liquids which allows for containers to be completely emptied and which volumetrically supplies a non-intermittent flow of materials.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a schematic view of a device according to an embodiment of the present invention;

FIG. 2 shows a detail of a device according to an embodiment of the present invention; and

FIG. 3 shows a schematic view of a device according to an embodiment of the present invention having a container placed therein.

### DETAILED DESCRIPTION OF THE INVENTION

The present invention relates to a mixing device for mixing at least two liquids, as well as to a process for mixing at least two liquids.

According to embodiments of the present invention, the pumps of the mixing device are screw spindle pumps and are connected to a follower plate, the follower plate being vertically adjustable and resting on the surface of the respective liquid and sealing the respective containers.

Such a mixing device guarantees a non-intermittent and volumetric flow rate. The mixing ratio can be freely chosen, when at least two containers are provided. The volumetric supplier makes volumetric measuring devices unnecessary. The mixing device according to the present invention is also energy-saving, as it does not require any volumetric measuring devices which cause a significant pressure drop. Volumetric measuring devices are not capable of detecting very small dosing quantities and require a minimum throughput. This may then result in incorrect mixing ratios. However, volumetric measuring devices may be optionally and additionally be used, in order to carry out parallel measurements to achieve greater measuring certainty and to additionally verify measurements.

Energy is saved by measuring the pressure of each component at the end of the tube immediately before the processing unit and controlling the speed of the associated suppliers. The feed pumps only have to create the required pressure, which is generated by the pressure drop within the tube. A pressure reducing valve, which reduces the system's pressure at the processing unit, is no longer required. It is assumed that, irrespective of different material viscosities, a highly exact mixing ratio can be achieved when mixing two materials at a constant pressure and adjusting the volumes supplied by the feed pumps.

### Advantages of the Screw Spindle Pump

A significant advantage of the screw spindle pump is its constant delivery pressure and its constant delivery volume. An exact mixing ratio can be guaranteed at any point in time. Previously used extrusion pumps supply a non-constant delivery flow, resulting in a short-term variation of the mixing ratio when the direction of movement is changed.

Another advantage of the screw spindle pump is the possibility to monitor the volume flow. Using a pressure sensor and the speed of rotation of the feed pump, characteristics of the medium to be delivered are determined. If these values differ from the determined values in the course of production, an alarm may be set off or the device may react adequately to the variation. It is, for example, possible to empty one container completely, as in this case the negative pressure at the inlet side becomes too great and the delivery pressure adapts to the speed of rotation.

Basically, the delivery of a screw spindle pump is a volumetric one. In case of liquids with very high viscosities, it is possible, however, that the screw spindle pump does not deliver the same volume with every rotation, as is the case of liquids with low viscosities. Such a variation, which is only small, may be easily determined based on calibration curves which, in certain cases, may also be established by the users themselves.

The screw spindle pump only needs a very small feed hopper on the follower plate and is arranged immediately at the lower edge of the follower plate. Such a configuration has the advantage that it is possible to empty the containers almost completely and that the amount of material which gets mixed with air when the barrels are changed is much smaller than when using one of the previously employed extrusion pumps. Thus, the amount of material which needs to be rinsed is smaller, allowing for saving material and time. There is also less rinsed material which needs to be disposed.

Another advantage of the screw spindle pump is the wide range of viscosities for which this feed pump may be used. Screw spindle pumps are capable of delivering materials ranging from water (viscosity of 1 mPa·s) to highly viscous media (3,000,000 mPa·s). The previously used extrusion pumps have a limited delivery range, in most cases of up to 1,500,000 mPa·s.

In one embodiment of the present invention, a tube may be provided after the pump in the delivery direction. Preferably, the tube includes a valve for adding additives. Adding an additive to the delivered liquid is often required in production processes. A color, a catalyst, a diluent, a dye, or the like may be added, for example. Additives may, for example, be added via additive valves, a certain amount of the respective additive being periodically added to the volume flow. The volume which is added over time depends on the feeding stroke and the dosing piston's diameter. Additives may be added discontinuously or continuously.

In another embodiment of the present invention, the liquid may have a viscosity ranging from 1 mPa·s to 3,000,000 mPa·s. As such, the device is suited for liquids having viscosities ranging from 1 mPa·s to 3,000,000 mPa·s. Such a mixing device may be used for mixing both low- and high-viscosity liquids. The liquids to be mixed may have the same viscosity or different viscosities.

In yet another embodiment of the present invention, the liquid may have a viscosity ranging from 100,000 mPa·s to 3,000,000 mPa·s. As such, the device is suited for liquids having viscosities ranging from 100,000 mPa·s to 3,000,000 mPa·s. Such liquids are particularly preferred for industrial applications.

In one embodiment of the present invention, the mixing device may comprise a rolling-in device for easily conveying the container to the place where it is emptied. Such a rolling-in device, for example, includes a plate on which the container may be placed and which may then be moved to the desired position within the device. It is thus not necessary to maneuvering the container to the right position in a cumbersome way.

In another embodiment of the present invention, the mixing device may have conveyor rollers. If the device has to be moved, it can be moved on its conveyor rollers. The conveyor rollers may be fixable and/or retractable. If the mixing device has arrived at the desired position, the conveyor rollers may thus be fixed and/or retracted, making sure that the mixing device can no longer shift out of place.

In one embodiment of the present invention, the follower plate may have an automatic ventilating valve. The container may be ventilated via the ventilating valve. After having placed the follower plate on the liquid surface, the container will inevitably contain air, which has to be removed before starting to discharge material from the container, as the air contained in the liquid must not enter the production process, resulting in incorrect measurements. Air is ideally removed via a ventilating valve.

In another embodiment of the present invention, a pressure sensor may be provided at the pump's outlet. This pressure sensor allows for measuring the pump's pressure, which in turn allows for drawing conclusions on any still contained amount of air and/or the delivered amount of liquid. A pressure sensor may, for example, be a manometer.

In another embodiment of the present invention, a control unit may be provided for controlling the automatic ventilating valve based on the delivery pressure measurements of the pressure sensor. The delivery pressure, with the ventilating valve closed, are compared to the reference value of a liquid free from air and the ventilating valve is opened as often and as long as required until the delivery pressure, when the ventilating valve is closed, corresponds to the reference value, whereupon the ventilating valve remains closed. This control unit allows for an automatic ventilation of the container. The delivery pressure for a liquid free from air is specific and changes when the liquid contains air. The pressure sensor measures the delivery pressure, and the control unit compares this delivery pressure with the reference value of the liquid free from air. If the values are not the same, the control unit opens the ventilating valve. The ventilating valve is closed again before the values are compared again. If the measured value and the reference value are the same, the ventilating valve remains closed, and the mixing process can be carried out.

In another embodiment of the present invention, the control unit may evaluate the number of rotations and the position of the rotational angle of the pump shaft and the pump drive. This also constitutes an efficient check of the liquid's air content.

In yet another embodiment of the present invention, sensors may be arranged at the lift cylinder. The sensors measure the level in the container and are connected to a regulating unit, which, in turn, is connected to the pump and via which regulating unit the pumps may be controlled to evenly empty at least two containers. The even emptying of two containers, for example, is particularly important for batch operations, as every container has its own batch number and there might be slight variations between different batches. For this reason, a container which has not been completely emptied cannot be used for mixing together with a new container; rather, the residual content has to be disposed of at the respective operator's expense. The arrangement of a sensor measuring the level within the container and controlling its emptying via the regulating unit avoids that residual liquid remains in a container, such that the two containers are completely emptied. For production reasons, the two containers used may not be not filled to the same level (this may, among other things, also be due to different viscosities of the liquids contained therein). In this case, it is necessary to adequately adjust the levels to one another.

Another aspect of the present invention relates to a process for mixing at least two liquids, at least two containers being arranged in a mixing device as described above, a follower plate sealing the respective container being placed on the liquid surface, the air between the liquid surface and the follower plate being removed and the liquids from the at least two containers being delivered by screw spindle pumps, the material flows being subsequently combined, resulting in a mixture. This process offers the advantage of a non-intermittent delivery and, thus, of the non-intermittent mixing of at least two liquids.

In one embodiment of the present invention, the air between the liquid surface and the follower plate can be removed by a control unit which controls an automatic ventilating valve based on measurements of the delivery pressure by the pressure sensor. The delivery pressure, with the ventilating valve closed, is compared to the reference value of a liquid free from air, and the ventilating valve is opened as often and as long as required until the delivery pressure, when the ventilating valve is closed, corresponds to the reference value, whereupon the ventilating valve remains closed. This control unit allows for an automatic ventilation of the container. A liquid free from air has a specific delivery pressure which changes when air in entrapped. The pressure sensor measures the delivery pressure and the control unit compares the delivery pressure with the reference value of the liquid free from air. If the values are not the same, the control unit opens the ventilating valve. The ventilating valve is closed again before the values are compared again. If the measured value and the reference value are the same, the ventilating valve remains closed.

In another embodiment of the present invention, the control unit may evaluate the number of rotations and the position of the rotational angle of the pump shaft and the pump drive.

This also constitutes an efficient check of the liquid's air content.

In one embodiment of the present invention, sensors may be arranged at the lift cylinder. The sensors measure the level in the container and are connected to a regulating unit, which, in turn, is connected to the pump and via which regulating unit the pumps may be controlled to evenly empty at least two containers. The even emptying of two containers, for example, is particularly important for batch operations, as every container has its own batch number and there might be slight variations between different batches. For this reason, a container which has not been completely emptied cannot be used for mixing together with a new container; rather, the residual content has to be disposed of at the respective operator's expense. The arrangement of a sensor measuring the level within the container and controlling its emptying via the regulating unit avoids that residual liquid remains in a container, such that the two containers are completely emptied. For production reasons, the two containers used may not be filled to the same level (this may, among other things, may also be due to different viscosities of the liquids contained therein). In this case, it is necessary to adequately adjust the levels to one another.

Another aspect of the present invention relates to the use of a mixing device, as described above, for mixing at least two liquids. Such a use allows for mixing at least two liquids without intermissions.

A further aspect of the present invention relates to the use of a mixing device, as described above, in a process as described above. Such a use allows for mixing at least two liquids without intermissions in such a process.

### EXAMPLES

### Example 1

An exemplary device of the present invention is structured as follows.

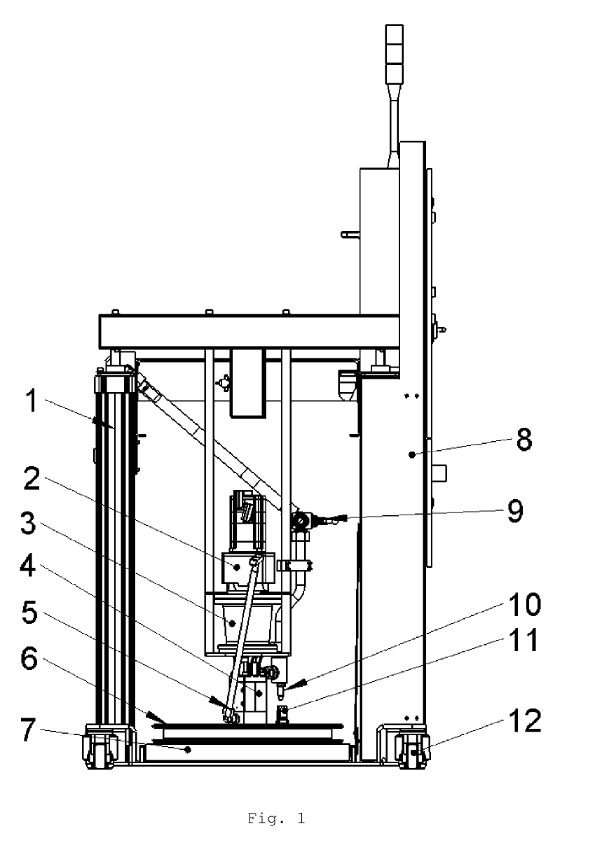

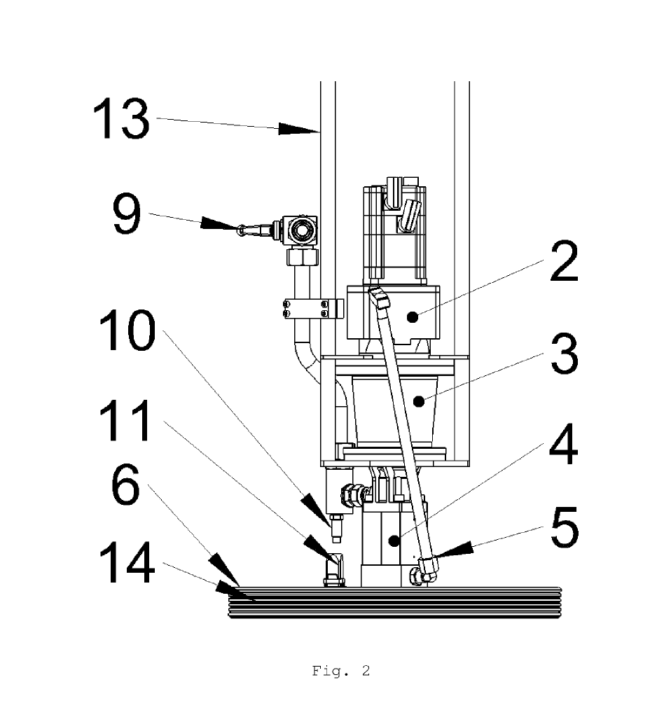

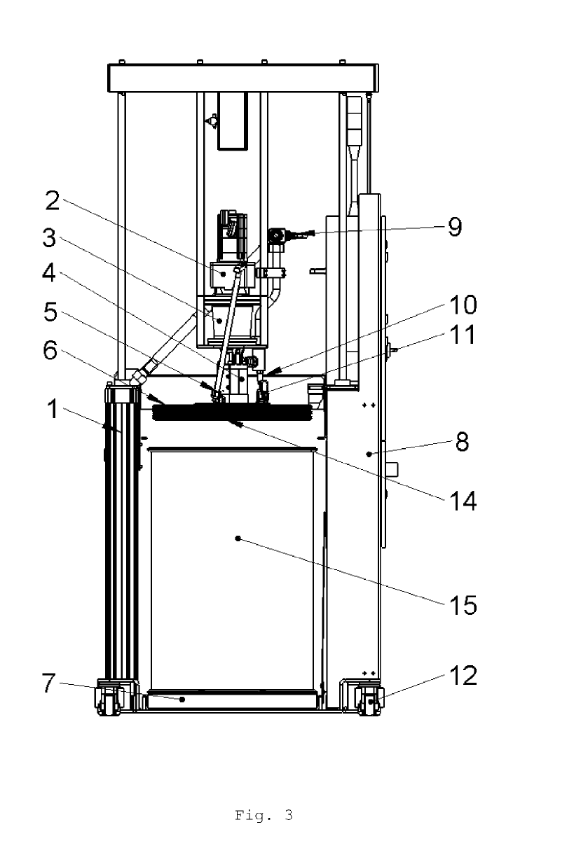

Referring to FIGS. 1-3, a lift cylinder 1 for the follower plate 6 is capable of moving the follower plate 6 upwards and downwards. The follower plate 6 may have different diameters and is adapted to the container 15 to be emptied. The follower plate 6 has a follower plate ventilation 5. When the follower plate 6 is placed on the container 15, air must be able to escape, which is ensured by the follower plate ventilation 5. A servo drive unit 2 with a gear is connected to the pump body 4 via a connecting flange 3. The drive movement is a rotary movement. The pump body 4 is a screw spindle pump. This screw spindle pump 4 is a constant current pump. A rolling-in device 7 for moving the container may be provided. This rolling-in device 7 may move the container 15 to its intended position below the pump 4 without great effort. The device may be covered by a casing 8 to cover sharp edges and improve operational safety. A slider 9 may be provided to switch between a ventilating position and an operating position. A pressure sensor 10 at the pump's outlet serves the purpose of pressure regulation and protecting the pump against excess pressure. A pressure sensor in the area of the processing unit serves the purpose of regulating the pressure within the device. The follower plate 6 may be connected to the delivery device via a plug-in connection 11 which encodes the follower plate's size. Transport rollers 12, which are fixable and/or retractable, are also provided. A connecting rod 13 serves the purpose of fixing the various parts. Recesses in the mounting base are intended for transporting the dosing device by means of a lifting truck or a forklift truck.

In most cases, the container 15 is a barrel. A static seal serves the purpose of sealing the container. It is possible to use an inflatable seal for 20- and 200-liter-barrels. This makes it possible to process barrels with minor defects. Advantages include that the variable seal may be adapted to the viscosity of the material to be delivered, an easier exchange of the containers 15, as the seal does not contact the follower plates when they are extended, so that the container 15 does not have to be lifted. The follower plates 6 may be light constructions (e.g., weight below 15 kg, such that occupational health and safety provisions allow for an exchange by the operating staff).

The device may be constructed on rollers 12 and a locking device may be integrated into the rollers 12, allowing for preventing the device from moving while in operation.

The tube may be guided by pivots, allowing for very short tube lengths in the area of the movable plates. This reduces the pressure drop and thus energy consumption.

Screw spindle pumps create a constant volumetric flow. The pressure within the processing unit is precisely regulated. This allows for drawing conclusions concerning the volumetric flow. As the material within the material tube is highly compressible and the tube expands, acting like reservoirs, the regulation loop has to take into account all interfering factors.

The liquids in the container may, for example, be liquid silicone rubber (LSR), adhesives, resins, food products, etc.

At least two of these devices are combined to form a mixing device according to the present invention. These at least two devices or devices for withdrawing liquids may be combined in a way that the at least two liquids can be withdrawn at a desired mixing ratio and are then transported through the exiting tube at the right mixing ratio. This means that the tubes from one device are then combined to form a single tube which then carries the liquids at the desired mixing ratio. It is also possible to provide more than two devices or devices for withdrawing liquids, depending on the desired liquids to be mixed.

### Example 2

### Injection Molding

Liquid silicone rubber (LSR) is most commonly used in traditional injection molding processes using an injection molding device. In this process, the material is dosed into the screw of the injection molding device at a mixing ratio of 1:1. The injection molding device then injects the material into a hot mold.

### Example 3

### Direct Casting

Other areas of application of these delivery and mixing devices include direct casting, in which the material is directly delivered into a tool without using an injection molding device. It is, of course, also possible to deliver other materials such as resins and adhesives.

### Example 4

The mixing block of a device as described in Example 2 may be equipped with a check valve to prevent one component from flowing back into the supply of the other component. It may be necessary to measure the material pressure of the already mixed materials after the blocking unit in order to make the controller more stable.

Optionally, the volumetric flow may be measured, as the exact respective volumetric flow has to be known to allow for adding precise amounts of additives.

### Example 5

When adding an additive, such as a color, the volumetric flow may be calculated based on the current number of rotations and the current pressure. The injection unit for adding additives injects the additive at an amount proportional to the volumetric flow.

### Example 6

When adding an additive, such as a color, the volumetric flow may be measured by means of volumetric measuring units. The injection unit for adding additives injects the additive at an amount proportional to the volumetric flow.

### Example 7

When directly injecting materials into molds for large-volume parts produced by a casting process, the material quantities required are often very high. The feed pump directly injects the material into the tool. The injection profile (e.g., quantity, time and the like) may be set via a user interface. Optionally, the injection may be controlled by sensors for sensing the pressure inside the mold.

### Example 8

### Automatic Ventilation

After a replacement of the containers, air enters the delivery system. It is required that this air is removed from the system. If the air remains inside the system, the downstream process will be strongly impaired, potentially resulting in production losses. If the air reaches the mostly longer material tubes, great amounts of material have to be flushed through the entire system. This manual process depends on the optical and acoustic perception of the operators. It is impossible to tell for sure whether all the air has been removed from the system. For this reason, in most cases, more material than necessary is discharged from the system, as it has to be free of bubbles when leaving the system for a certain period of time.

To remove the air, an automatic ventilating valve 5 is integrated into the follower plate 6 or arranged on the follower plate 6 of a device according to Example 1, and the ventilating valve may be opened and closed by the control unit. The pressure sensor 10 mounted at the pump's outlet measures the delivery pressure. The number of rotations and the position of the rotational angle of the pump shaft and the pump drive are evaluated.

The operator actuates the controls for lowering the follower plate 6 into the material container. The delivery device realizes when the follower plate 6 lies on the liquid or the air cushion within the barrel 15 (no change of the follower plate's position) and opens the follower plate's ventilation 5. The trapped air at the pump's inlet and the amount of the material are evacuated via the follower plate 6. The ventilating valve 5 is closed after a determined period of time. Afterwards the pump 4 initiates the measuring process in the closed hydraulic system. If the pressure sensor 10 does not measure the reference value (i.e., the value of the liquid free from air), the ventilating valve 5 is opened again to let the air escape. If the next measurement result corresponds to the reference value, the ventilating valve 5 remains closed and the device enters its automatic mode of operation.

A second automatic valve 9 may optionally be mounted at the pump's outlet, which reduces the pump pressure to allow for another measurement of the air.

The pump pressure may optionally also be reduced by reversing the delivery direction of the pump (reversal of the direction of rotation) to allow for another measurement of the air.

The ventilating slide 5 may optionally also be manually actuated (the operator will be prompted by the control by means of a dialog).

The principle of evaluation is defined so that the pump 4 starts rotating and the information from the pressure sensor 10 at the pump's outlet is compared to the pump's 4 rotational angle. If air is present within the system or at the pump's inlet, this is evaluated based on the relationship between pressure and rotational angle. This information is compared to standard values (for systems free from air). Based on the pressure increase in relation to the pump's 4 rotation, conclusions may be drawn on trapped air (compressibility of the material). It is also possible to carry out an evaluation based on the pressure's pulsation. If the device finds air inside the system, the built-up pump pressure is reduced and the ventilating valve 5 on the follower plate 6 is opened to release a certain amount of material and air. Then, the ventilating valve 5 is closed again and another measurement is carried out to find out whether there is still air inside the system. This process is repeated until the pressure increase curve is stable and has reached the standard values.

### Example 9

### Compensating for Different Levels

As it is possible that the materials to be mixed have different viscosities, this may lead to an unequal emptying of material containers in devices with volumetric delivery volumes and a mixing ratio of 1:1. In practice, the containers supplied by the manufacturers are not filled to the same levels in many cases (different volumes of components A and B). As the containers A and B have to be emptied simultaneously (e.g., via a batch process) and cannot be selectively replaced, a fixed mixing ratio results in the containers being emptied unequally and in residual material remaining in one of the containers, while the other container is already completely empty. As such, in some cases, there may be 10% residual material left in one of the containers, which cannot be processed and thus has to be disposed of as hazardous waste. This results in an increased environmental burden and in higher costs for the user.

Depending on the manufacturers, silicones with a slight deviation of +−5% (depending on the manufacturer's fact sheet) may be mixed. This allows for approximation of the mixing ratio, so that the containers are emptied simultaneously (if the level does not exceed +5% of maximum deviation).

The material containers are replaced at the same time, and, after the ventilating process, the levels are determined by a sensor arranged at the lift cylinder 1. The required mixing ratio is calculated based on the deviation. The control unit then controls the pump 4 so that the two containers are equally and completely emptied. The required mixing ratio is recalculated in the course of production to compensate for any viscosity differences in the containers.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims

1-17. (canceled)

18. A mixing device for mixing at least two liquids, the device comprising:
at least two containers (15), each container containing a liquid; and
at least two pumps (4) for delivering the liquid of each container, each of the pumps (4) being arranged at one of the containers (15),
wherein the pumps (4) are screw spindle pumps which are connected to a follower plate (6), the follower plate being vertically adjustable and resting on a surface of a respective liquid thereby sealing a respective container (15).

19. The mixing device according to claim 18, further comprising a tube provided after the pump (4) in a delivery direction, the tube having a valve for adding additives.

20. The mixing device according to claim 18, wherein the liquid has a viscosity ranging from 1 mPa·s to 3,000,000 mPa·s.

21. The mixing device according to claim 18, wherein the liquid has a viscosity ranging from 100,000 mPa·s to 3,000,000 mPa·s.

22. The mixing device according to claim 18, further comprising a rolling-in device (7) for transporting the at least two containers (15) to a place where the at least two containers are emptied.

23. The mixing device a cording to claim 18, further comprising conveyor rollers (12).

24. The mixing device according claim 18, wherein the follower plate (6) has an automatic ventilating valve (5).

25. The mixing device according to claim 24, further comprising a pressure sensor (10) is provided at the pump's outlet.

26. The mixing device according to claim 25, further comprising a control unit configured to control the ventilating valve (5) by measuring a delivery pressure at the pressure sensor (10),
wherein the delivery pressure, with the ventilating valve (5) being closed, is compared to a reference value of a liquid free from air, and
wherein the ventilating valve (5) is opened as often and as long as required until the delivery pressure, when the ventilating valve (5) is closed, corresponds to the reference value, whereupon the ventilating valve (5) remains closed.

27. The mixing device according to claim 26, wherein the control unit evaluates a number of rotations and a position of a rotational angle, of a pump shaft and a pump drive.

28. The mixing device according to claim 26, further comprising sensors arranged on a lift cylinder (1) the sensor measuring a level in the container (15) and being connected o a regulating unit which is connected to the at least two pumps (4), the at least two pumps (4) being controllable via the regulating unit to evenly empty the at least two containers (15).

29. A method for mixing at least two liquids, the method comprising:
in a mixing device according to claim 18, at least two containers (15) are arranged and a follower plate (6), sealing the respective container, is placed on the liquid surface,
air is removed from between the liquid surface and the follower plate (6), and
the liquids are delivered from the at least two containers (15) using the screw spindle pumps (4), such that the material flows are subsequently combined and result in a mixture.

30. The method according to claim 29, wherein the air between the liquid surface and the follower plate (6) is removed by a control unit controlling an automatic ventilating valve (5) based on measuring a delivery pressure at a pressure sensor (10);
wherein the delivery pressure, with the ventilating valve (5) being closed, is compared to a reference value of a liquid free from air; and
wherein the ventilating valve (5) is opened as often and as long as required until the delivery pressure, when the ventilating valve (5) is closed, corresponds to the reference value, whereupon the ventilating valve (5) remains closed.

31. The method according to claim 30, wherein the control unit evaluates a number of rotations and a position of a rotational angle of a pump shaft and a pump drive.

32. The method according to claim 30, wherein sensors measuring a level in the container (15) and connected to a regulating unit, which in turn is connected to the pump (4), are arranged on a lift cylinder (1), the regulating unit controlling the at least two pumps (4) to evenly empty the at least two containers (15).

33. The use of a mixing device according to claim 18 for mixing at least two liquids.

34. The use of a mixing device in a method according claim 29.
